(19) United States
(12) Patent Application Publication
(10) Pub. No.: US 2021/0180471 A1
(43) Pub. Date: Jun. 17, 2021

(54) Power Generation Method and System Using Working Fluid with Buoyancy Engine

(71) Applicant: Robert LeRoy Wright, Plano, TX (US)

(72) Inventor: Robert LeRoy Wright, Plano, TX (US)

(21) Appl. No.: 17/173,126

(22) Filed: Feb. 10, 2021

Related U.S. Application Data
(63) Continuation-in-part of application No. 16/861,346, filed on Apr. 29, 2020, now abandoned.

(51) Int. Cl. F01K 7/16; F01K 27/00; F03G 6/00; F03G 7/04

(52) U.S. Cl. CPC F01K 7/16; F01K 27/00; F05D 2220/31; F03G 7/04; F03G 6/003

(57) ABSTRACT

A method and mechanical system which incorporates a buoyancy engine into an Organic Rankine Cycle to create mechanical energy which may be used to generate electricity. The modified ORC consists of a closed loop containing a high molecular mass working fluid. The working fluid is vaporized in an evaporator, powers a buoyancy engine, and is recovered in a condenser. The system then utilizes a gravity feed to provide sufficient pressure at the evaporator input. The system can be implemented on a residential scale, capable of operating near ambient temperatures and pressures, and can produce carbon free electric power.

### CROSS-REFERENCE TO RELATED APPLICATIONS

This application is a continuation-in-part of and claims priority to U.S. application Ser. No. 16/861,346, filed Apr. 29, 2020. This application also claims the benefit of U.S. Provisional Patent Application No. 62/973,408, filed Oct. 4, 2019, the disclosure of which is herein incorporated by reference in its entirety. This application also claims the benefit of U.S. Pat. No. 8,456,027, filed Nov. 3, 2010, the disclosure of which is herein incorporated by reference in its entirety.

### BACKGROUND

### Field

The present invention is related to power generation systems.

### Description of Related Art

The Rankine Cycle (RC) is the thermodynamic cycle of a mechanical system which converts the temperature and pressure energy of steam into mechanical power using a turbine which drives an electric generator. The RC system comprises: a working fluid (typically water), a feed pump to pressurize the liquid phase working fluid, an evaporator to heat the pressurized liquid thereby changing from liquid phase to vapor phase, a turbine to generate mechanical power from the high pressure high temperature vapor, and a condenser to cool the vapor phase thereby changing back to a liquid phase which is then returned to the feed pump to continue the cycle. Modern steam plants are based upon the RC and are designed for high efficiency utilize supercritical steam condition (up to 3,765 pounds per square inch absolute (psia) pressure and 1,049° F.).

The Organic Rankine cycle (ORC) is a Rankine Cycle modified by substituting the water working fluid with an organic high molecular mass fluid (such as a refrigerant) as a working fluid. The ORC system comprises: a working fluid, a feed pump to pressurize the liquid phase working fluid, a evaporator to heat the pressurized liquid thereby changing from liquid phase to vapor phase, a turbine or expander (such as a scroll expander) to generate (rotational) mechanical power from the high pressure high temperature vapor, and a condenser to cool the vapor phase thereby changing back to a liquid phase which is then returned to the feed pump to continue the cycle. This allows operation at lower temperatures than the traditional Rankine Cycle but the continued use of a turbine or expander still demands supercritical temperatures and pressures. The operating temperatures and pressures vary with the source of heat, the selected working fluid and the selected turbine, however a presentation at the International Seminar on ORC Power Systems, September 2017, Milano, Italy described a system with 261 psia pressure and a highest temperature of 224° F.

The turbine, described in the Organic Rankine Cycle, is a machine in which a rotor fitted with vanes is made to revolve by a fast-moving flow of gas or air. Dictionary.com (from Oxford Languages) October, 2020.

The turbine operates when a high-pressure high-velocity stream of gas enters the cylindrical casing, striking the angled vanes causing the rotor to spin and produce mechanical power. The motive force is the kinetic energy of the flowing gas. The force pushes against the vanes in the direction of the rotor imparting a rotational force which causes the rotor to turn and produce mechanical power.

The present invention improves on the ORC by substituting a buoyancy engine for the turbine or expander and removing the feed pump. The buoyancy engine utilizes the vapor phase of the ORC working fluid to displace a liquid within the buoyancy engine thereby creating a buoyant force. The buoyant force is then utilized by the internal mechanism of the engine to rotate an output shaft which may be used to drive an electric generator. The buoyancy engine will operate effectively with a pressure as low as 17 psia at ambient temperatures. By locating the working fluid condenser above the level of the evaporator the gravity head of the liquid working fluid from the condenser to the evaporator will provide the required 17 psia pressure. These improvements allow the present invention to provide electricity to individual residences using an ambient temperature heat source.

The buoyancy engine described in the present invention is defined as a machine which uses buoyant force, as described by Archimedes' Principle, to generate mechanical power.

Archimedes' Principle teaches: Any body completely or partially submerged in a fluid (gas or liquid) at rest is acted upon by an upward, or buoyant force, the magnitude of which is equal to the weight of the fluid displaced. (Encyclopedia Britannica on-line, October 2020).

The buoyancy engine operates when a flowing gas is captured and displaces the liquid inside a bucket. The motive force is the buoyant force of the submerged bucket. This buoyant force causes the bucket(s) to rise, rotating the sprockets to produce mechanical power.

### BRIEF SUMMARY OF INVENTION

The present invention is a method and associated equipment utilizing a working fluid heated to achieve a phase change from liquid to vapor at ambient temperatures and pressures as low as 17 psia, injected into a buoyancy engine producing mechanical power to drive a generator to produce electricity. The vapor phase is collected at the top of the buoyancy engine and condensed from vapor phase back to liquid phase at ambient temperatures and then fed by gravity back to the heated evaporator.

In some disclosed embodiments, the present invention (a modified ORC) uses a closed loop arrangement consisting of an evaporator whose output is coupled to the bottom of a buoyancy engine, and a condenser coupled to the vapor output at the top of the buoyancy engine. In some embodiments the working fluid has a molecular mass no less than 50 grams per mole. In some disclosed embodiments the evaporator is situated below the buoyancy engine. Further, in some disclosed embodiments the condenser is situated above the evaporator. In some embodiments an optional flow control device is utilized to control system operation. In some embodiments the buoyancy engine incorporates a continuous loop of open-bottom buckets.

### BRIEF DESCRIPTION OF DRAWINGS

FIG. 1 is a schematic view of the equipment components of a traditional Organic Rankine Cycle driving a turbine (or expander) connected to a generator to produce electricity.

FIG. 2 is a schematic view of the equipment components of the present invention driving an example of a buoyancy engine, consisting of a continuous loop of open-bottom buckets, connected to a generator to produce electricity.

FIG. 2a is a detailed view of the upper and lower ends of the continuous loop of open-bottom buckets.

FIG. 3 is a flow diagram showing the step-by-step actions of the equipment components for the present invention.

### DETAILED DESCRIPTION OF INVENTION

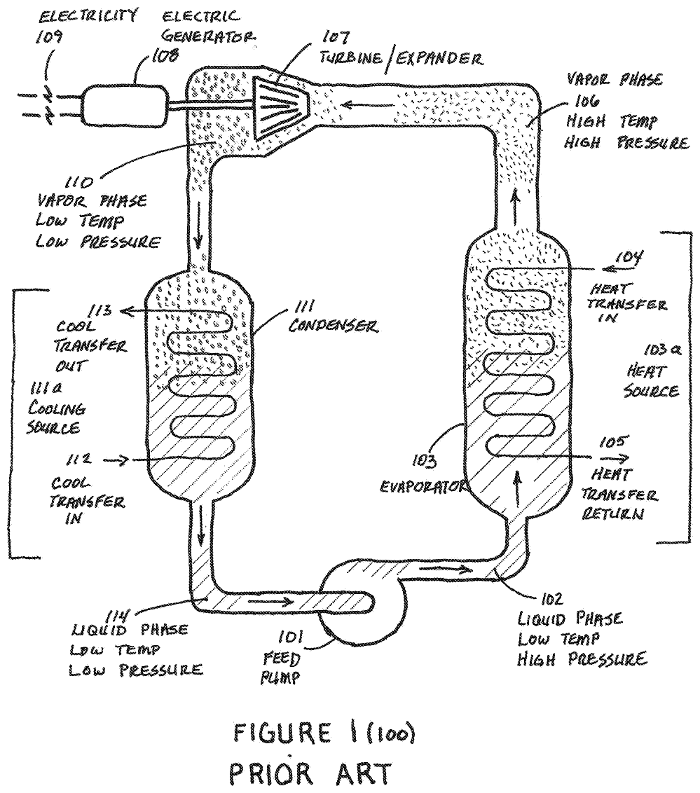

FIG. 1 (100) shows a schematic layout of a traditional Prior Art Organic Rankine Cycle (ORC). The feed pump 101 receives low temperature, low pressure liquid phase working fluid 114 and increases the pressure. The resulting low temperature, high pressure working fluid, shown as 102, flows to the evaporator 103. A high temperature transfer fluid 104 from the outside heat source 103a enters the evaporator 103 at the top and exits as a low temperature transfer fluid 105 from the bottom. While flowing through the evaporator the working fluid changes from a low temperature, high pressure liquid phase 102 to a high temperature, high pressure vapor phase 106. This vapor phase enters the turbine (or expander) 107 which produces mechanical power thereby driving a generator 108 to produce electricity output 109. The vapor flow leaves the turbine (or expander) as a reduced temperature, low pressure vapor phase 110. The working fluid continues into the condenser 111 where a cooling transfer fluid 112 from an outside cooling source 111a enters in the bottom and exits out the top as cooling transfer fluid return 113. While flowing through the condenser the working fluid changes from a reduced temperature, low pressure vapor phase 110 to a low temperature, low pressure liquid phase 114. The liquid phase 114 then flows to the feed pump 101 to repeat the cycle.

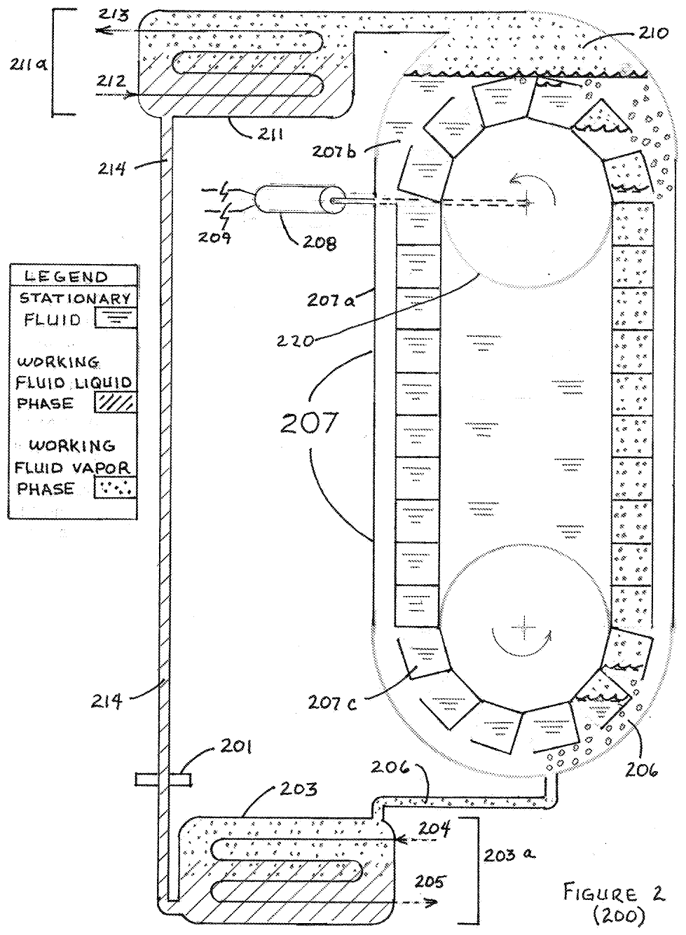

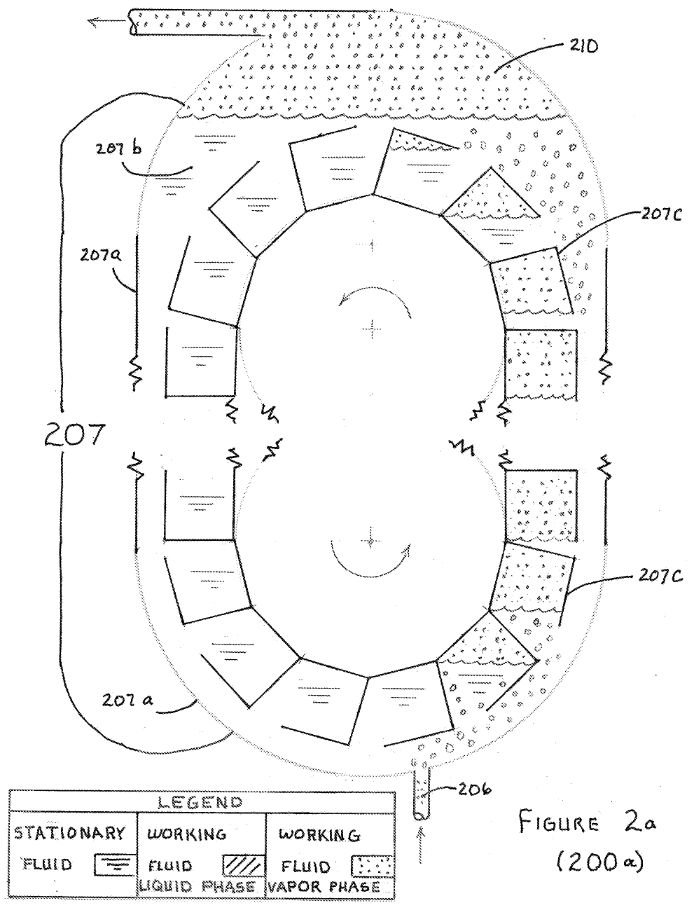

The present invention incorporates the evaporator 103 and the condenser 111 of the ORC (FIG. 1) but removes the feed pump 101 and replaces the turbine/expander 107 with a buoyancy engine 207, as shown in FIG. 2.

A schematic layout of the present invention (200) is shown in FIG. 2. The optional variable flow control device (such as a valve or equivalent) 201 controls the flow rate of the liquid phase working fluid 214 into the evaporator 203. This working fluid is a high molecular mass material with a molecular mass no less than 50 grams per mole and can change from liquid to vapor and return to liquid during an operational cycle. A heat transfer fluid 204 from the outside heat source 203a enters the evaporator 203 at the top and exits as heat transfer fluid return 205 from the bottom. While flowing upward through the evaporator 203 the working fluid changes from a liquid phase 214 to a vapor phase 206. This vapor phase 206 has adequate pressure to enter the bottom of the buoyancy engine 207 due to the gravity head created by an elevation difference between the condenser 211 and the evaporator 203. An example buoyancy engine is found in U.S. Pat. No. 8,456,027 (Seehorn), incorporated by reference, comprising: an enclosed vessel filled with a buoyancy liquid (commonly water), a mechanism to capture the incoming vapor phase working fluid, and a mechanism to utilize the buoyant force created when the vapor phase working fluid displaces said buoyancy liquid to produce mechanical power. The mechanical power can be configured to drive an electric generator, or other desired units. Another example of a buoyancy engine is shown in FIG. 2. Device 207 consists of: a vessel 207a containing a stationary body of fluid 207b, a flowing vapor phase 206, and a mechanical system 207c submerged into said body of stationary fluid 207b and configured with a plurality of open-bottom buckets connected to a continuous chain engaging upper and lower sprockets to translate vertical motion to rotational motion. One or more sprocket(s) is mounted on a horizontal shaft to transmit mechanical power. FIG. 2 (200) shows a generator 208, coupled to the upper sprocket 220, which produces electric power output 209. The working fluid exits the top of the buoyancy engine 207 in a vapor phase 210 at the same temperature but slightly lower pressure than working fluid vapor phase 206 at the bottom of the buoyancy engine 207. Working fluid then flows as vapor phase 210 to the condenser 211 where a low temperature transfer fluid 212 from an outside cooling source 211a enters the bottom and exits out the top as low temperature transfer fluid return 213. While flowing through the condenser the working fluid changes from a vapor phase 210 to a liquid phase 214. The condenser 211 is located above the elevation of the evaporator 203 such that gravity will provide adequate pressure for injection of the vapor phase 206 into the bottom of the buoyancy engine 207.

FIG. 2a shows a detailed view of the working fluid vapor phase 206 entering the bottom of the buoyancy engine 207, captured and displacing the stationary fluid 207b inside the right-most (inverted) buckets of the mechanical system 207c thereby generating a buoyant force on those individual buckets. It is this buoyant force which causes the right-most buckets to rise, thereby rotating the sprockets in a counter-clockwise manner. FIG. 2a also shows a detailed view of the working fluid vapor phase 210 exiting the top of the buoyancy engine 207 thereby allowing the stationary fluid 207b to enter the buckets of the mechanical system 207c which removes the buoyant force previously acting on the individual buckets.

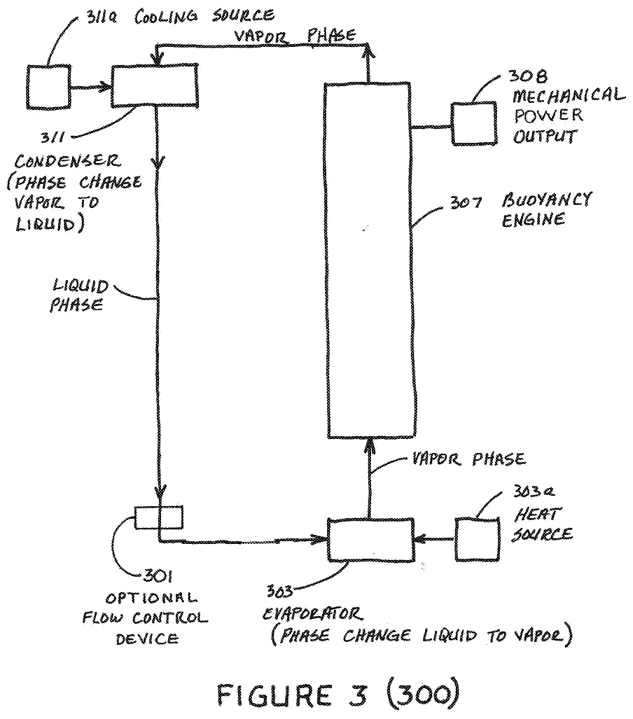

FIG. 3 (300) shows a flow chart of the method for the present invention. The optional flow control device 301 controls the flow rate of the liquid phase working fluid into the evaporator 303. An outside heat source 303a provides heat to the evaporator 303 which heats the working fluid to change from liquid phase to vapor phase. The vapor phase working fluid flows up (rises) through the buoyancy engine 307 which produces mechanical power. In one embodiment this mechanical power could drive a generator 308 to produce electricity. The vapor phase working fluid flows up out of the buoyancy engine 307 and into the condenser 311. An outside cooling source 311a removes heat from the condenser 311 which cools the working fluid to change from vapor phase to liquid phase. The liquid phase working fluid then returns to the evaporator 303 for the cycle to be repeated.

Those of ordinary skill in the art will recognize and appreciate that the application of said mechanical power is not limited to the generation of electricity. Rather, many additions, deletions, and modifications to the illustrated embodiment may be made without departing from the scope of the invention as hereinafter claimed, including legal equivalents thereof.

### Examples

With the introduction of a buoyancy engine into the mechanical operation of the traditional Organic Rankine Cycle (ORC) the present invention extends the lower limits of heat required (heat source) for operation down to ambient temperatures. The traditional ORC is restricted to industrial locations providing a free (or very low cost) supply of high temperature heat (i.e. industrial waste heat, high temperature geothermal, large scale Combined Heating and Power (CHP), etc.) to generate electricity. The present invention makes it possible to produce mechanical power (capable of, but not limited to, driving a generator to produce electricity) at small scale locations such as a residence or small commercial structure. At the same time the present invention will also operate at any higher temperature locations suitable for the traditional ORC. The following examples describe application potentials:

### Residential—Warm Climate

The heat source in a warm climate could be the non-conditioned attic air space, a solar heater, the roof of a building, geothermal HVAC, the warm air in the living spaces of the residence, or ambient atmospheric heat. The cooling source could be groundwater, an adjacent stream, geothermal HVAC, or a local pond/lake. When operated in this configuration the electricity could be considered carbon free.

### Residential—Cold Climate

The heat source in a cold climate could be the furnace or water heater combustion air exhaust, or hot circulating air at the furnace discharge, or the warm air in the living spaces of the residence, or hot water from the water heater. The cooling source could be the ambient external temperature. When operated in this configuration with a natural gas fired furnace the electricity could qualify as combined heating and power (CHP). When operated with a biomass (i.e. wood) furnace the electricity could qualify as renewable power.

### Geothermal/Warm Springs

The system could be installed at a geothermal source with a temperature below that necessary to drive either the traditional high temperature steam system or a traditional ORC system. The cooling source could be either shallow groundwater or ambient outside temperatures. When operated in this configuration the electricity could be considered carbon free.

### Existing Power Plants

The system could be installed at any existing coal fired, gas fired, biomass, or nuclear power plant. Each of these systems utilize the Rankine Cycle to drive a steam turbine and must condense the steam back to water in a continuous operation. The water used to condense the steam could be a source of heat for the Present Invention. The cooling lake associated with the power plant could also provide the cooling necessary for the present invention. When operated in this configuration the energy harvesting produces electric power from waste heat.

### Tropical Islands

The system could be installed on islands located in the tropics. The typical ambient temperatures could provide the necessary heat source and a pipeline into the adjacent ocean could provide the cooling source. When operated with this configuration the electric power could be considered carbon free.

### Ocean Thermal Energy Conversion (OTEC)

The Present Invention could be located off-shore on a platform and utilize the shallow water as a heat source and deeper water as the cooling source. With this configuration the electric power could be considered carbon free.

### Industrial

Manufacturing, mining, and other industrial operations often generate waste heat during operation. This waste heat could be a potential source of heat for the present invention. The cooling source could either be shallow groundwater or ambient atmospheric temperatures. When operated in this configuration the energy harvesting produces electric power from waste heat.

### Internal Combustion Engines (ICE)

Large ICE engines fueled by diesel, natural gas, gasoline, and biogas are used to generate electric power and drive pipeline compressors. The engine cooling fluid, the combustion exhaust, and compressor heat are all potential sources of heat for the present invention. The cooling source could either be shallow groundwater or ambient atmospheric temperatures. When operated in this configuration the energy harvesting produces electric power from waste heat.

### Oil Field Brine

Hot brine coproduced with oil and gas could be a potential source of heat for the present invention. The cooling source could either be shallow groundwater or ambient atmospheric temperatures. When operated in this configuration the energy harvesting produces electric power from waste heat

### SUMMARY

Those of ordinary skill in the art will recognize and appreciate that the ability to utilize ambient (or greater) temperature to produce mechanical power offers potential applications beyond the selected examples shown herein. The evaporator described in the present invention is simply a device to add heat to a fluid (either liquid phase or vapor phase) and is not restricted to the construction details used in historic applications. The condenser described in the present invention is simply a device to remove heat from a fluid (either liquid phase or vapor phase) and is not restricted to the construction details used in historic applications. The example buoyancy engine described in the present invention is simply a device that utilizes the buoyant force of a liquid to develop mechanical power. The heat source described in the present invention has no restrictions other than the temperature must be high enough to cause the working fluid to transition from liquid phase to vapor phase. The cooling source described in the present invention has no restrictions other than the temperature must be low enough to cause the working fluid to transition from vapor phase to liquid phase. Many additions, deletions, and modifications to the illustrated embodiments may be made without departing from the scope of the invention as hereinafter claimed, including legal equivalents thereof.

All documents referenced herein are hereby incorporated by reference.

What is claimed is:

1. A method of generating mechanical power comprising:
a. heating a working fluid from liquid phase to vapor phase in an evaporator;
b. injecting said working fluid vapor into a buoyancy engine, wherein the buoyancy engine generates mechanical power;
c. cooling said working fluid vapor exiting the buoyancy engine to said liquid phase in a condenser; and
d. returning said working fluid liquid to the evaporator.

2. The method of claim 1, wherein the working fluid has a molecular mass no less than 50 grams per mole.

3. The method of claim 1, further comprising controlling the flow rate of the working fluid liquid returned to the evaporator.

4. The method of claim 1, wherein the mechanical power is used to generate electric power.

5. (canceled)

6. The method of claim 1, wherein a heat source for heating said working fluid is at least one of non-conditioned attic air of a building, ambient atmospheric heat, a combined heating and power furnace, geothermal, upper extent of a body of water, solar collector, waste heat, exhaust heat, the roof of a building, or oil field brine.

7. The method of claim 1, wherein a cooling source for cooling said working fluid is at least one of groundwater, water flowing through the ground, lower extent of a body of water or ambient outside air.

8. The method of claim 1, further comprising elevating said condenser above said evaporator to provide sufficient gravity head pressure to operate said buoyancy engine.

9. A system for generating mechanical power comprising:
an evaporator;
a buoyancy engine, wherein said buoyancy engine contains a stationary fluid;
a condenser; and
tubing, wherein said tubing connects said evaporator to said buoyancy engine, said buoyancy engine connects to said condenser, said condenser connects to said evaporator in a closed loop containing a high molecular mass working fluid.

10. The system of claim 9, wherein the working fluid has a molecular mass no less than 50 grams per mole.

11. The system of claim 9, further comprising a flow control device located between the evaporator and the condenser.

12. The system of claim 9, wherein the buoyancy engine output shaft is coupled to an electric generator.

13. (canceled)

14. The system of claim 9, wherein the evaporator is coupled to a heat source, wherein said heat source is at least one of the non-conditioned attic air of a building, ambient atmospheric heat, a combined heating and power furnace, geothermal, upper extent of a body of water, solar collector, waste heat, exhaust heat, the roof of a building, or oil field brine.

15. The system of claim 9, wherein the condenser is coupled to a cooling source, wherein said cooling source is at least one of groundwater, water flowing through the ground, lower extent of a body of water or ambient outside air.

16. The system of claim 9, wherein said condenser is elevated with respect to said evaporator to provide sufficient pressure to operate said buoyancy engine.

17. The system of claim 9, wherein the top of said buoyancy engine is coupled to said condenser and the bottom of said buoyancy engine is coupled to said evaporator.

18. The system of claim 9, wherein the buoyancy engine is filled with a stationary fluid whose molecular weight is less than that of the working fluid.

19. The method of claim 1, wherein the buoyancy engine is filled with a stationary fluid whose molecular weight is less than that of the working fluid.
